(19) United States
(12) Patent Application Publication
(10) Pub. No.: US 2021/0392352 A1
(43) Pub. Date: Dec. 16, 2021

(54) METHOD AND SYSTEM OF MULTI-LAYER VIDEO CODING

(71) Applicant: Intel Corporation, Santa Clara, CA (US)

(72) Inventors: Vasily Aristarkhov, Nizhny Novgorod (RU); Kseniya Tikhomirova, Nizhny Novgorod (RU); Changliang Wang, Bellevue, WA (US); Ximin Zhang, San Jose, CA (US); Sergey Solodkov, Nizhny Novgorod (RU)

(73) Assignee: Intel Corporation, Santa Clara, CA (US)

(21) Appl. No.: 17/373,986

(22) Filed: Jul. 13, 2021

(51) Int. Cl. H04N 19/37; H04N 19/142; H04N 19/137; H04N 19/105; H04N 19/503

(52) U.S. Cl. CPC H04N 19/37; H04N 19/142; H04N 19/503; H04N 19/105; H04N 19/137

(57) ABSTRACT

Techniques related to video coding include multi-layer video coding with content-sensitive cross-layer reference frame re-assignment.

### BACKGROUND

A video encoder compresses video information so that more information can be sent over a given bandwidth or stored in a given memory space or the like. The encoder has a decoding loop that decodes video frames it has already compressed in order to imitate the operation of a remote decoder and determine residuals or differences between the decoded frame and the original frame so that this difference or residual can be compressed and provided to a decoder as well to increase the accuracy and quality of the decoded images at the decoder. The encoder uses temporal or inter-prediction to decode a current frame by using redundant image data of reference frames to reconstruct the current frame.

Many of the video coding standards use a multi-layer inter-prediction structure where each layer provides frames to enable a different streaming frame rate. For example, a base layer provides the slowest frame rate, say 15 frames per second (fps) for video streaming, while a middle layer provides frames that together with the frames of the base layer may provide frames at 30 fps for video streaming, and a highest layer may provide more frames together with the frames of the lower layers that can provide frames at 60 fps video streaming. To obtain video coding and streaming at a target fps, a decoder uses the frames on the layer of the desired frame rate and only those layers below that target frame rate layer. For the inter-prediction at the encoder, frames on higher layers can use frames on a lower layer as reference frames but not the other way around to maintain the layered structure so that a decoder does not need to decode any more frames than is necessary to maintain the target frame rate. This strict structure, however, can result in drops in image quality and spikes in bandwidth consumption, that can cause visible drops in image quality and undesirable and annoying pauses in streaming video.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1 is a conventional multi-layer temporal structure for inter-prediction and frame rate management;

FIG. 2 is another conventional multi-layer temporal structure for inter-prediction and frame rate management;

FIG. 3 is a schematic diagram of an example encoder according to at least one of the implementations herein;

FIG. 4 is a schematic diagram of an example decoder according to at least one of the implementations herein;

FIG. 5 is an example method of multi-layer video coding according to at least one of the implementations herein;

FIG. 6 is an example detailed method of multi-layer video according to at least one of the implementations herein;

FIG. 7 is an example multi-layer temporal structure for inter-prediction and frame rate management according to at least one of the implementations herein;

FIG. 8 is another example multi-layer temporal structure for inter-prediction and frame rate management showing the results of the structure of FIG. 7 according to at least one of the implementations herein;

FIG. 9 is an alternative example multi-layer temporal structure for inter-prediction and frame rate management showing the results of the structure of FIG. 7 according to at least one of the implementations herein;

FIG. 10 is another alternative example multi-layer temporal structure for inter-prediction and frame rate management showing the results of the structure of FIG. 7 according to at least one of the implementations herein;

FIG. 11 is yet another alternative example multi-layer temporal structure for inter-prediction and frame rate management according to at least one of the implementations herein;

FIG. 12 is a further alternative example multi-layer temporal structure for inter-prediction and frame rate management showing the results of the structure of FIG. 11 according to at least one of the implementations herein;

FIG. 13 is an illustrative diagram of an example system;

FIG. 14 is an illustrative diagram of another example system; and

FIG. 15 illustrates an example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as servers, laptops, set top boxes, smart phones, tablets, televisions, computers, etc., may implement the techniques and/or arrangements described herein. Further, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as DRAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, it is submitted that it is within the knowledge of one skilled in the art to affect such feature, structure, or characteristic in connection with other implementations whether or not explicitly described herein.

Methods, devices, apparatuses, systems, computing platforms, mediums, and articles described herein are related to multi-layer video coding.

As mentioned above, it may be advantageous to use temporal scalability to encode a video sequence so that different decoders with different frame rate and bandwidth requirements can each have access to the same video bitstream. Thus, one decoder may only stream video at 60 fps, while a different decoder may only be able to stream video at 30 fps. The multi-layer inter-prediction structure with temporal layers at the encoder enables such frame rate adaptability of the same bitstream. The decoder need only determine which layers to use to achieve the target frame rate. As a result, the temporal layers also mitigate the impact of packet loss in a network streaming the video. In other words, since the layers already have a reference frame pattern structure that permits a decoder to select a certain combination of the temporal layers, only frames on an unselected layer are dropped. No other frames need to be dropped (or quality reduced) due to a frame losing its reference frame.

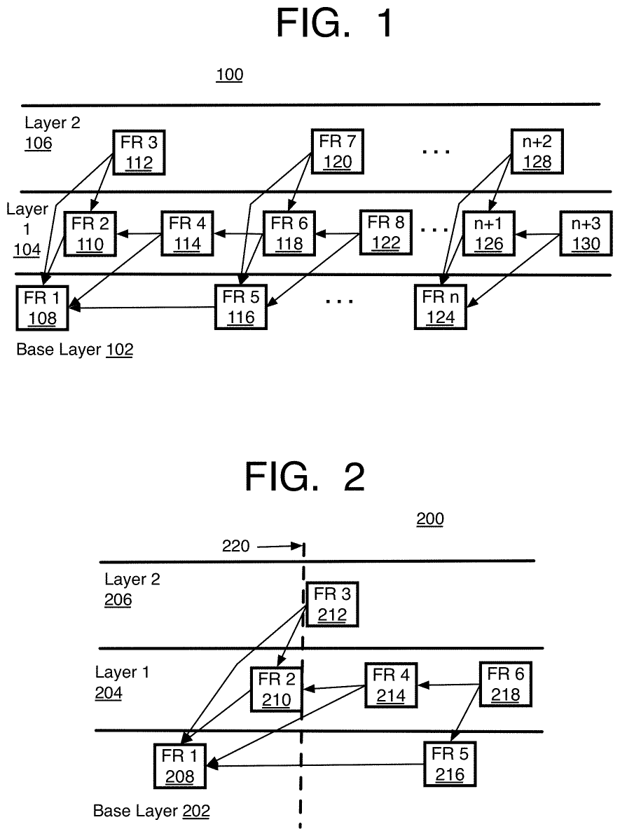

Referring to FIG. 1 for example, a conventional inter-prediction temporal layer structure 100 divides a video stream into several layers that each represent a different frame rate. This includes a base layer 102 and multiple enhancement layers 104 and 106. Each layer can be decoded independently from upper layers above it. The video sequence of the bitstream here is shown from frames 1 (108) to frame n+3 (130) numbered evenly, where frames 1, 5, and n are on the base layer 102, frames 2, 4, 6, 8, n+1, and n+3 are in an upper layer 1 (104) just above the base layer 102, and frames 3, 7, and n+2 are in an upper layer 2 (106) above upper layer 1 (104). The known encoders use known patterns and frame orders to encode temporal scalability as shown on structure 100. For the present example then, the base layer (102) frames can be defined as 4n+1; the enhanced layer 1 (104) frames include all frames from the base layer plus frames 4n+2 and 4n+4; and the enhanced layer 2 (106) have all frames from layer 1 plus frames 4n+3. The frames 108 to 130 are shown in decoder order here since in this example, no B-frames are used that use reference frames from both ahead and behind a current frame. So here where a current frame can only use previous frames as reference frames, the decoder order matches the display order (or temporal order) on the multi-layer structure 100, but the order could be different so that the structure 100 and the other structures shown herein could be showing just the display order and not the actual decoder order.

Specifically, in a typical scenario of low-latency video streaming with temporal scalability, multi-layer structure 100 demonstrates encoding of IPPPPP frames where no B frames are provided in order to provide a low-latency mode with the three temporal layers 102, 104, and 106. In this example, the base layer 102 may provide a frame rate of 15 fps, layer 1 (104) may provide a frame rate of 45 fps, and layer 2 (106) may provide a frame rate of 60 fps. The reference dependencies are shown as arrows where the arrow points towards the reference frame, which is decoded before the frame using it as a reference and where the arrow originates. So for example, frame 1 (108) is the reference frame for frames 2-5. Frame 1 (108) itself could be an intra-prediction frame (or I-frame) since it does not use any reference frame during its own reconstruction.

Different coding standards such as AVC, HEVC, VP9, AV1, and so forth, may have different syntax to mark the placement of frames on the temporal layers, but the reference dependency structure is usually common across the codecs where the encoder builds reference frame lists without depending an upper layer frame on a lower layer reference frame to avoid the packet and frame losses mentioned above. Usually, an encoder uses neighbor frames in temporal order as references. On the base layer 102, other than a first I-frame (108), the frames each have a reference frame on the same layer (the base layer 102). For example, frame 5 (116) uses frame 1 (108) as a reference frame. On the example upper layer 1 (104), the frames each have two reference frames: one on the base layer (102) and one on its own layer (104). For example, frame 6 (118) has reference frame 4 (114) on the same layer and reference frame 5 (116) on the base layer. On the upper layer 2 (106), each frame has two reference frames with one on the base layer (102) and one on the upper layer 1 (104). As shown according to the standards, no reference dependencies are available or permitted from a lower layer to an upper layer by temporal scalability structures. Thus, for instance, frame 5 (116) can only use frame 1 (108) as a reference frame, but cannot use frame 2 (110), 3 (112), or 4 (114) as reference frames.

When temporal scalability is used by cloud gaming, live streaming, or video conferencing applications that operate in or near real-time to provide a good experience for a user viewing the video, an additional requirement can exist to deliver frames at all temporal layers with minimum delay to attempt to avoid video pauses or bad quality video. This is more complex than scalability-free use cases because of the limitations mentioned on the reference list for base or lower layers. Such limitations may seriously impact visual quality and lead to video freezes when scene changes or fast motion are present in the video.

Referring to FIG. 2 for example, the difficulties arise when an abrupt change in image data content occurs from frame to frame such as with a scene change or very fast motion 218. When such a scene change or fast motion starts on the base layer 202 (in display or temporal order as shown) of a multi-layer structure 200, this is handled without additional delays because the base frames 1 or 5 have no or one reference frame so that only a single frame (frame 1 or 5) needs to be reconstructed using a large amount of bits rather than a reference frame. This base frame 1 or 5 then can be used as a reference frame for frames on any of the layers while already factoring the screen change or fast motion (also referred to as a content event). Thus, for example, frame 6 can still use updated frame 5 as a reference frame and with better accuracy in light of a scene change at frame 5 for example. This is relatively efficient and does not necessarily cause relatively long delays in the encoding for real-time video.

However, when a scene change or fast motion 220 first occurs at an upper layer such as layers 1 (204) or 2 (206), the conventional techniques for handling such situations with static temporal scalability patterns are inadequate. For example, say a scene change 220 occurs as shown by the dashed line and right before upper frame 3 (212) on upper-most layer 2 (206). To accommodate the scene change, the encoder has to spend a lot of bits to encode frame 3, but frame 3 cannot be used as a reference frame for other temporal layers such as frame 4 and frame 5 that will be affected by the scene change 220. Due to the scene change, frames 4 and 5 will need to be decoded with more intra-coding blocks on the frame, which have a larger bit cost than inter-prediction, and less inter-prediction blocks (or other partitions). Therefore, the bit sizes and bandwidth consumed to decode frames 4 and 5 spike, and the encoder-side decoding becomes very inefficient. When multiple frames of a video sequence need to be reconstructed either by reducing the number of blocks that can use reference frames or without using reference frames entirely where slower and heavier bit-cost intra-prediction must be favored due to the abrupt and large change of image data content, this is referred to as “big-size propagation”, and can cause delay or pauses as well as poor quality frames in the streaming video. Such strict multi-layer inter-prediction cannot achieve low-delay streaming.

The attempts to compensate for the big-size propagation with fixed temporal layer patterns usually involves only managing an encoder quantization parameter (QP) to achieve the required bit rate (or frame rate) per stream either cumulatively for all temporal layers or per temporal layer. When a scene change or fast motion occurs at one of the enhanced layers, the conventional encoders cannot use frames from the upper layer as references for the base or lower layer. As a result, the conventional encoders either increase the QP for frames at the base layer to meet bandwidth requirements but which negatively impacts visual quality, or consumes more bandwidth to keep the QP low, but that increases latency and may lead to picture freezes at the client devices anyway.

To resolve these issues, the disclosed method of multi-layer video coding minimizes the impact of scene changes and fast motion first appearing on upper layer frames so that low-delay streaming applications still can be provided with good quality video at or near real-time. This can be accomplished by analyzing the content of the frames and re-assigning an upper layer frame to lower layers depending on the content characteristics (or image data content) of the upper layer frame. When the upper layer frame is a first frame along the video sequence that has a scene change or fast motion for example, the structure of the temporal layers can be adjusted to improve quality of the frames and minimize overall bit rate of the frames. The adjustment includes re-assigning upper frames from upper temporal layers to lower or base layer(s) by changing the reference lists of the frames maintained by the encoder for inter-prediction. Then the frames on the same, now lower or base, layer can use that re-assigned frame as a reference frame. The upper frames can use the re-assigned frame as a lower layer reference frame as well. Optionally, a lower frame can be moved to an upper layer in order to compensate for the first re-assignment in order to maintain a frame count on each layer that will derive the target frame rate for each layer despite the frame re-assignment. Such re-assignment in the opposite direction also may be performed to adhere to strict reference dependency pattern requirements. The result is more accurate predictions and image quality while achieving either similar or reduced latency.

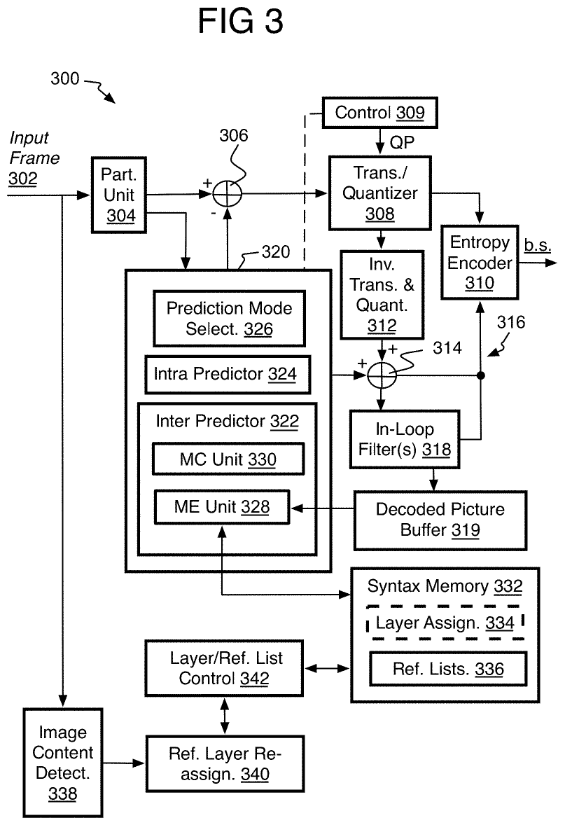

Referring now to FIG. 3, an image processing system 300 may be, or have, an encoder to perform multi-layer video coding arranged in accordance with at least some implementations of the present disclosure. The encoders and decoders mentioned herein may be compatible with a video compression-decompression (codec) standard such as, for example, HEVC (High Efficiency Video Coding/H.265/MPEG-H Part 2), although the disclosed techniques may be implemented with respect to any codec such as AVC (Advanced Video Coding/H.264/MPEG-4 Part 20), VVC (Versatile Video Coding/MPEG-I Part 3), VP8, VP9, Alliance for Open Media (AOMedia) Video 2 (AV1), the VP8/VP9/AV1 family of codecs, and so forth.

As shown, encoder 300 receives input video 302 and includes a coding partition unit 304, an encoder control 309, subtractor 306, a transform and quantization module 308, and an entropy encoder 310. A decoding loop 316 of the encoder 300 includes at least an inverse quantization and transform module 312, adder 314, in-loop filters 318, a decoded picture buffer (DPB) 319, also referred to as a reference frame buffer, and a prediction unit 320. The prediction unit 320 may have an inter-prediction unit 322, an intra-prediction unit 324, and a prediction mode selection unit 326. The inter-prediction unit 322 may have a motion estimation (ME) unit 328 and a motion compensation (MC) unit 330. The ME unit 328 is able to determine which frames are reference frames of a current frame being reconstructed by looking up a reference list 336 of the current frame. The ME 328, and in turn the MC unit 330, may select alternative references for the same current frame in order to test which reference(s) provide the best current image quality. The reference lists 336 as well as layer assignments 334 may be held in a syntax memory or buffer 332 that holds data and settings of one or more frames and that will be placed in the frame's network adaption layer (NAL) including in a frame or slice header or other partition header or overhead, depending on the codec being used. Other details are provided below. The multi-layer reference frame re-assignment operations may be performed by an image content detection unit 338 and a reference layer re-assignment unit 340 that provides instructions to a layer or reference list control unit 342 as described below. It will be appreciated that layer/reference list control 342 could be part of control 309.

In operation, encoder 300 receives input video 302 as described above. Input video 302 may be in any suitable format and may be received via any suitable technique such as fetching from memory, transmission from another device, captured from a camera, etc. By one example form for high efficiency video coding (HEVC), this standard uses the coding units (CUs) or large coding units (LCU). For this standard, a current frame may be partitioned for compression by the coding partitioner 304 by division into one or more slices of coding tree blocks (e.g., 64×64 luma samples with corresponding chroma samples), in turn divided into coding units (CU) or partition units (PUs) for motion-compensated prediction. CUs may have various sizes in a range from 64×64 to 4×4 or 8×8 blocks, and including non-square rectangular sizes as well. The present disclosure is not limited to any particular CU partition and PU partition shapes and/or sizes, and this applies similarly to other video coding standards such as a VP_ standard that refers to tiles divided into superblocks that are similar in size to CUs for example.

As shown, input video 302 then may have the partitioned blocks of the frames provided to the prediction unit 320. Specifically, mode selection module 326 (e.g., via a switch), may select, for a coding unit or block or the like between one or more intra-prediction modes, one or more inter-prediction modes, or some combination of both when permitted. Based on the mode selection, a predicted portion of the video frame is differenced via subtractor 306 with the original portion of the video frame to generate a residual. A transform and quantizer unit 308 divides where the frames, or more particularly the residuals, into transform blocks, and are transformed (e.g., via a discrete cosine transform (DCT) or the like) to determine transform coefficients. The coefficients are then quantized using QPs set by the encode control 309. The control 309 also may provide settings for the prediction unit 320 such as permitted prediction mode selections, and so forth. The quantized transform coefficients may be encoded via entropy encoder 310 and then packetized with overhead data described below and into an encoded bitstream. Other data, such as motion vector residuals, modes data, transform size data, reference lists, layer assignments as described herein, or the like also may be encoded and inserted into the encoded bitstream.

Furthermore at the decoding loop 316, the quantized transform coefficients are inverse quantized, and the coefficients are inverse transformed via inverse quantization and transform module 312 to generate reconstructed residuals. The reconstructed residuals may be combined with the aforementioned predicted portion at adder 314 and other re-assembly units not shown to re-construct a reconstructed or decoded frame, which then may be filtered using refinement in-loop filters 318 to generate a reconstructed frame. The decoded frame is then saved to a frame buffer (or decoded picture buffer (DPB)) 319 and used as a reference frame for encoding other portions of the current or other video frames. Such processing may be repeated for any additional frames of input video 302.

Of particular relevance here, while the DPB 319 stores the image data (such as the YUV luma and chroma pixel values) of the frames to be used as reference frames, other memory such as a syntax memory 332 may store the overhead data to be placed in frame headers, slice headers, other partition headers, or otherwise parameter sets located between frames when placed in a bitstream depending on the codec. The overhead data is packed into the bitstream with the image data once the image data is compressed. The overhead data also may or may not be compressed depending on the level of syntax, location of frame field, and which codec is being used. The overhead data may include both layer assignments and reference frame lists, also referred to as reference picture set (RPS) lists in HEVC for example. The reference lists list which prior frames in decoding order can be a reference frame for a frame being reconstructed. A layer/reference list control 342 may manage the layer and reference list data for the frames. Which reference frames can be placed on a list can depend on the codec inter-prediction structure, encoder parameter settings, and a size of the DPB 319 in terms of how many frames, or how much of a frame, can be stored at once. The control 342 places the frames on the reference lists 336.

In some cases, when the layers are assigned purely by frame type, such as I, P, or B frames, and/or frame order such as IPPP, the layer assignment is inherent to the structure and is omitted. In other structures, the layer of a frame cannot be determined without the layer assignment. Thus, the layer assignment, when provided, and the reference list of a frame, may be provided in headers or parameter sets depending on the specific format and syntax of the codec being used, but generally is similar from codec to codec. For example, in AVC or HEVC, the layer and reference list is often placed in the network abstraction layer (NAL) sequence parameter set (SPS), picture parameter set (PPS), and/or slice headers. In other codecs, such as VC1 or MPEG2, the reference lists may be determined from the decoded picture buffer content because in these systems, the type of frame indicates which frames are to be reference frames for that frame. For example, in IPPP where the P frames always and only use the consecutive previous frame as the reference frame, no list is needed. The list is considered to be inherent in the frame order. In this case, the re-assignment described herein cannot change which frame is a previous frame to a current frame.

Specifically for temporal scalability where the reference frame pattern can be complex, and in AVC by one example, the basic reference list structure parameters may be encoded as a supplemental enhancement information (SEI) message as part of a scalable video coding (SVC) extension of the codec and as an NAL unit. The reference lists themselves may be placed into corresponding frame or slice headers. So with this structure, a decoder can retrieve a frame header to obtain information data that indicates which buffered (or previous) frames should be used as reference frames.

For the layer re-assignment operations described herein, the image content detection unit (or circuit) 338 obtains original input frame content (before partitioning and compression by the encoder itself) and performs algorithms to determine if a frame has such an image content event that causes a temporal break from a previous frame such that the frame cannot adequately rely on its reference frames alone to generate an accurate prediction during inter-prediction, and should be reconstructed (or decoded) by using more bits, which may or may not result in reconstructing the frame without references similar to an I-frame. By one form, dependency to base layer frames still may be maintained. This unit 338 may perform scene change detection and fast motion detection on individual or each frame that is not initially an I-frame (or I-slice) by one example. Other details are provided below.

When such a frame is found to be a scene change or fast motion frame, referred to herein as a temporal break frame, content event frame, or simply a trigger frame, a reference layer re-assignment unit or circuit 340, determines which other frames are to use the temporal trigger frame as a reference frame. Any reference frame dependencies, or layer change, that are changes from the existing initial structure are provided to the control 342 to make the re-assignment updates on the reference lists 336 and layer assignments 334 of the frames. As discussed below, this may proceed frame by frame, or slice by slice, and as the encoder is handling the frames. By one approach, the image content detection and re-assigning could be performed as soon as the control 342 generates the reference list for a frame. By yet another alternative approach, the content detection could be performed beforehand by running through an entire video, or entire scene or other part of the video sequence being encoded, since the content detection is being performed on data of the original frames that would already have a display order count, rather than reconstructed frame data. In this case, the re-assignment indicators could be provided to the control 340 beforehand, which then uses the indicators to generate the reference lists as needed.

Otherwise, the operations may proceed frame by frame, and CU by CU on each frame by one example. Any other modules of the encoder are known to those of skill in the art and are not discussed further herein with respect to FIG. 3 for the sake of clarity in presentation. The details are provided below.

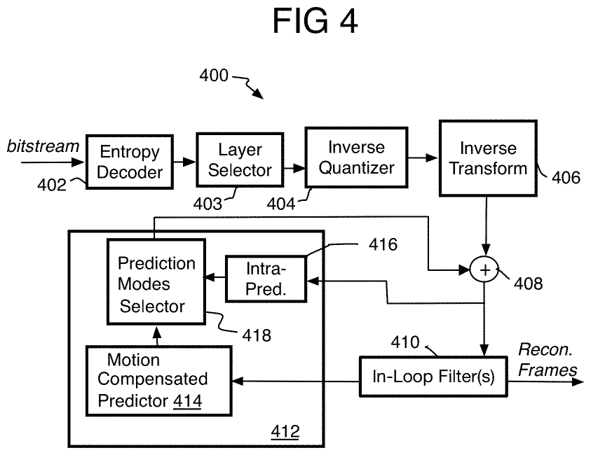

Referring to FIG. 4, a system 400 may have, or may be, a decoder, and may receive coded video data in the form of a bitstream and that has the image data (chroma and luma pixel values), residuals in the form of quantized transform coefficients, and inter-prediction data including layer assignments and reference lists in frame, slice, or other partition headers, overhead, and/or parameter sets. The inter-prediction data also may include prediction modes for individual blocks, other partitions such as slices, inter-prediction motion vectors, partitions, quantization parameters, filter information, and so forth. The system 400 may process the bitstream with an entropy decoding module 402 to extract the quantized residual coefficients as well as the context data. The decoder then may have a layer selector 403 that indicates which frames are to be decoded so that only the frames needed to generate a video stream at a target frame rate or bit rate is decoded. Thus, say multi temporal-layer structure has a base frame for 15 fps, a higher layer for 30 fps, and a highest layer for 60 fps. For a decoder that only decodes for video streams of 30 fps, the layer selector reads the layer assignments and only sends frames of the base layer and first higher layer for decoding. The frames of the highest layer are dropped. The system 400 then may use an inverse quantizer module 404 and inverse transform module 406 to reconstruct the residual pixel data.

The system 400 next may use an adder 408 (along with assemblers not shown) to add the residual to a predicted block. The system 400 also may decode the resulting data using a decoding technique employed depending on the coding mode indicated in syntax of the bitstream, and either a first path including an intra predictor module 416 of a prediction unit 412 or a second path that is an inter-prediction decoding path including one or more in-loop filters 410. A motion compensated predictor 414 utilizes reconstructed frames as well as inter-prediction motion vectors from the bitstream to reconstruct a predicted block.

The prediction modes selector 418 sets the correct prediction mode for each block as mentioned, where the prediction mode may be extracted and decompressed from the compressed bitstream. A block assembler (not shown) may be provided at the output of the selector 418 before the blocks are provided to the adder 408 as needed.

The functionality of modules described herein for systems 300 and 400, except for the units related to the layer re-assignment for example and described in detail herein, are well recognized in the art and will not be described in any greater detail herein.

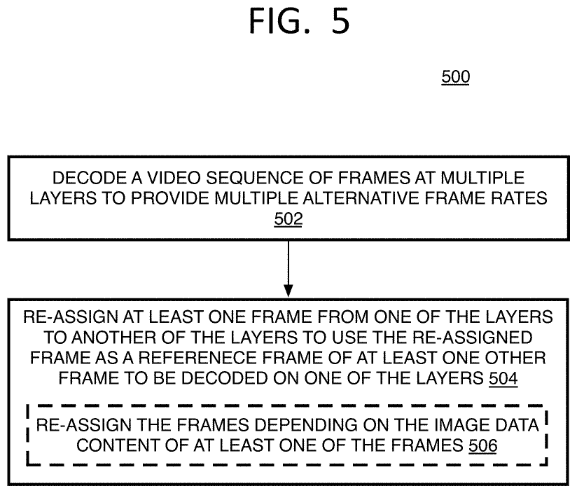

Referring to FIG. 5, an example process 500 for multi-layer video coding is arranged in accordance with at least some implementations of the present disclosure. Process 500 may include one or more operations 502-506. Process 500 may form at least part of a video coding process. By way of non-limiting example, process 500 may perform a coding process as performed by any device or system as discussed herein such as system or device 300, 400 and/or 1300.

Process 500 may include “decode a video sequence of frames at multiple layers to provide multiple alternative frame rates” 502. Thus, an original video may be received at an encoder to be compressed. This operation may include sufficient pre-processing of the original video for encoding. The process described here also may be related to the decoding loop at the encoder. Thus, this operation also refers to video that already may have been partitioned, compared to predictions to generate residuals, and then had the residuals compressed by a transform and quantization process before providing it to the decoding loop. Then, at least some of the frames may be decoded or reconstructed with inter-prediction of an entire frame, slice, or other frame partition to be propagated for the prediction operations described herein. The inter-prediction may use the multi-temporal layer structure described herein to provide different layers to be used for different frame rates at a decoder.

By one form, the frames already decoded may be used as reference frames for frames not yet decoded according to the multi-layer structure and decoding frame order. By one form, and at least initially as mentioned herein, frames in the higher layers can only use frames in the same layer or a lower frame, which may be a base layer, as a reference frame to limit the number of frames that need to be decoded to achieve a target frame rate or bit rate.

Process 500 may include “re-assign at least one frame from one of the layers to another of the layers to use the re-assigned frame as a reference frame of at least one other frame to be decoded on one of the layers” 504. This may include changing the reference frame dependency (or pattern) so that a frame originally of an original upper layer is to be used as a reference frame for at least one frame on a lower layer that is lower relative to the original upper layer. The result is a change in the reference frame dependency pattern that is more efficient by reducing the computational load and number of bits that need to be used to decode some of the frames.

To accomplish this, this operation may include “re-assign the frames depending on the image data content of at least one of the frames” 506. Specifically, the image data content or content event may be detected by performing motion detection to search for differences in image data that indicate a large change in image data between pairs of consecutive frames on the video. When a large amount of change exists, this usually indicates either fast motion or a scene change. When this occurs on a pair of frames, this indicates that the later frame cannot adequately rely on earlier reference frames since the later frame has such a large number of pixels with new image data. Such a frame that cannot be adequately rebuilt by using its reference frame(s) as much as initially desired then requires more intra-coding modes either alone or to be provided as candidates with the inter-prediction prediction modes of fewer blocks (or other partitions) of the frame to reconstruct at least part of the frame, and all of which result in more bits to reconstruct the frame.

When one frame needs more bits for the re-construction, each layer will have a first frame that needs such reconstruction as well, except for when the frame is on the base layer. When on the base layer, the changed base frame will be a root for the following frames anyway such that no re-assignments are needed. However, when a frame of an upper layer needs the higher bit-cost decoding, and multiple upper layers exist, then the other upper layer(s) will each have a first frame that is affected by the content event (or scene change, etc.) and will need to be reconstructed with more effort as well, thereby duplicating too much effort, raising the bit cost and bandwidth of the frames, and thereby lowering efficiency. Thus, redundant decoding can be avoided by re-assigning the first upper layer frame, in decoding order, that needs the higher bit reconstruction to a lower layer or the base layer so that it can be used as a reference frame at least for each of the first frames needing the larger bit reconstruction on the other upper layers.

Thereafter, the multi-layer frame structure may be used for inter-prediction of the frames moving forward, where the reference frame dependencies may be re-arranged again when the frame content indicates such re-assignments are desirable again as described. This can be repeated as many times as necessary through-out a video sequence being analyzed.

The frame layers and reference frame assignments, when not inherent in other frame structure, such as I, P, or B frame type and frame order, may be transmitted with the compressed image data to decoders, whether placed in frame, slice, or other frame partition headers, overhead, between frames, in NAL units of the frames, and/or as metadata being transmitted with the frames as described herein. The decoder then decodes the frames using inter-prediction reference frames according to the transmitted or inherent layer assignments and reference frame dependencies.

It will be understood that the re-assignments may be performed on the fly as original frame pairs are analyzed and then encoded (a first frame is just encoded, then the original first and next frames are analyzed, and then the next frame is encoded as the current frame, and so forth), but could be performed beforehand since the content detection may be performed on original image data rather than the reconstructed data. In the former case, a video sequence may be analyzed ahead of time to determine which frames are to be re-assigned to a lower layer and have its reference frame dependencies changed, and this may be provided to the re-assignment unit of the encoder for example and reference list/layer assignment control to update reference lists and layer assignments, or wait for those frames to be placed in the DPB to perform the updating. It also should be noted that the comparison can be between the current original frame and previous reconstructed frame instead.

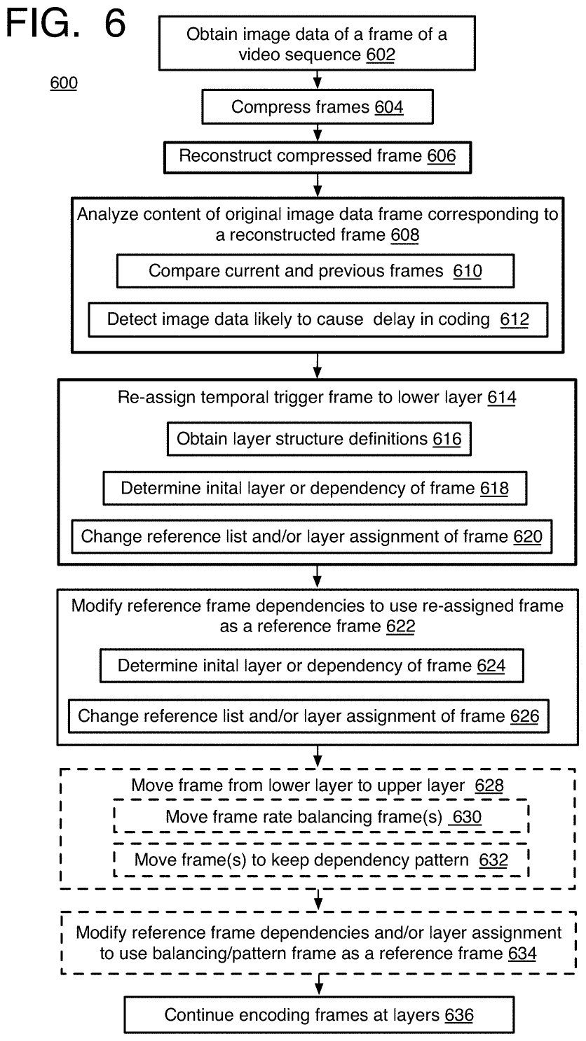

Referring to FIG. 6, an example process 600 for multi-layer video coding is arranged in accordance with at least some implementations of the present disclosure. Process 600 may include one or more operations 602-620 generally numbered evenly. Process 600 may form at least part of a video coding process. By way of non-limiting example, process 600 may perform a coding process as performed by any device or system as discussed herein such as system 300, 400, and/or video processor system or device 1300 (FIGS. 3, 4, and 13 respectively), and may be described by referring to those systems.

Process 600 may include “obtain image data of a frame of a video sequence” 602, and as mentioned above, may include luminance and chroma data pre-processed sufficiently for encoding, but is otherwise as described above with systems 300, 400, or 1300 and process 500.

Process 600 may include “compress frames” 604. This may involve having an encoder compress the video frames by compressing residuals between predictions and original versions of the frames.

Process 600 then may include “reconstruct compressed frame” 606, and to obtain decoded frames from the decoding loop of the encoder for inter-prediction so that the decoded frames can be used as reference frames for subsequent frames of the video sequence not yet decoded.

Process 600 may include “analyze content of original image data frame corresponding to a reconstructed frame” 608. By one form, this operation involves “compare current and previous frames” 610. Particularly, it involves comparing an original frame that corresponds to a decoded frame that was just decoded, and compared to a consecutive previous original frame. So by this form, the analysis is performed on the fly just as each frame is decoded and can be used as a reference frame. Two original frames are used for the analysis since the frames are readily available at the encoder and more accurate than the reconstructed frames. Thus, by another alternative, the frame analysis could be performed beforehand, rather than on the fly, where all of multiple individual frames are indicated for re-assignment throughout a video sequence to be encoded. This may be performed before the video sequence starts being provided to the decoding loop of the encoder for example.

This operation also may include “detect image data likely to cause delay in coding” 612. In other words, and as mentioned herein, layers to be re-assigned to a different layer are those layers that have image data content that is likely to cause delay in coding because the content changed too much from a previous frame such that the current frame cannot just rely on a reference frame to provide accurate reconstructed image data on the current frame. The consecutive previous frame may or may not be the reference frame for the current frame. When the current frame is likely to have content that causes delay, the current frame must be reconstructed using less inter-prediction, or in other words, using less inter-prediction blocks, and instead use more bit-costly intra-prediction modes on blocks (or other partition) in a frame to create prediction candidates for a prediction mode selector for example. By one form, the detection analysis uses algorithms to detect a scene change or fast motion such as optical flow, background subtraction (double background models), known blur sum of absolute differences (SADs), global motion, or other differences compared to thresholds, and so forth.

By one form, this comparison of frames is performed on a frame-level without regard to slices, blocks, or other frame partitions formed by the encoder.

Also by one form, the detection process is only performed with initially-assigned non-base layer frames since re-assignment is not necessary for initial base layer frames as explained above. The initial layer of the frame can be determined by layer assignment already provided in a syntax database or memory for example. Otherwise, the type of frame (I, P, or B), and/or frame order when the layers are fixed by a certain frame order may inherently indicate which layer a frame is on.

Process 600 may include “re-assign temporal trigger frame to lower layer” 614. Thus, if a current frame is found to indicate a scene change or fast motion, or other such content event, from a previous frame, and it is the first frame on any upper layer to have such changed content, in most cases this first or trigger frame of all layers may be re-assigned to the base layer, although it could be simply lowered to a lower upper layer if desired instead.

Referring to FIG. 7 for example, a multi-layer structure 700 has a base layer 702, middle or upper layer 1 (704), and a highest upper layer 2 (706). Frames are shown in their initial positions on the layer structure 700 where frames 1 (708) and 5 (718) are in the base layer, frames 2 (710), 4 (716), and 6 (722) are in upper layer 1 (704), and frame 3 (712) is in upper layer 2 (706). The thin arrows represent reference frame dependencies where the arrow points from the subsequent frame and toward the previous reference frame. Initially, the frames only depend from frames on the same layer or frames on a lower layer. Also, initial frame 3, or initial position of frame 3, (712) is shown in dashed line since this frame is a first frame of any upper layer that is affected by a scene change 724 and may be re-assigned in this scenario.

Specifically for the example of layer structure 700, the scene change 724 occurs along the video sequence so that frame 3 (712) is the first upper layer frame (here from left to right or in decoding order) that has image data that was detected as described above in operation 608 to indicate the scene change. Thus, frame 3 (712), which may be referred to as a content trigger frame or just trigger frame, then may be re-assigned (as shown by thick arrow 726) to the base layer 702 (or to layer 1 (704)). The re-assignment can be considered to form a new position of frame 3 (714) now already decoded with image data factoring the scene change to be used as a reference frame for frame 4 (716), which is the first frame of layer 1 (704) that will have image data impacted by the scene change. Once frame 3 is re-assigned, frame 4 (716) can use frame 3 (714) as a reference frame and does not need to be decoded with a significantly larger amount of bits.

To accomplish the re-assignment, process 600 may include “obtain layer structure definitions” 616, where this may be obtained from the syntax memory as mentioned above. Otherwise, the frame type and order may inherently indicate layer assignments and reference frame dependencies. All of the layer and reference frame dependencies may be obtained ahead of time once generated by the layer and reference list control, but otherwise may be obtained on the fly as needed when a reconstructed form of the frame is placed in the DPB and content detection analysis of the frame is performed.

Thereafter, process 600 may include “determine initial layer and/or dependency of frames” 618, which may include obtaining a reference list and layer assignment of a first trigger frame to be re-assigned due to the image data content, and as mentioned below, of the frames that initially use the first trigger frame as a reference frame, if any, as well as the first trigger frame of each layer and that is a trigger frame due to the same image data content (e.g., the same scene change).

Process 600 may include “change reference list and/or layer assignment of frame” 620. This operation performs updating of the reference lists, and layer assignments when saved as well, of the frames to accomplish the re-assignment. Thus, frame 3 (714) has its dependency changed from frame 2 (710) to frame 1 (708). The initial dependency to frame 2 (710) is shown in dashed line and is now eliminated. This operation removes frame 2 from the reference list of frame 3 and adds frame 1 instead, which is shown by the solid dependency line from frame 3 to frame 1 on structures 700 and 800. Note in this case, actually since frame 1 has content of the previous scene before the scene change, the reference frame dependency in this case is not critical and may or may not be dropped. Similar to the reference lists, the layer assignment also may be changed and may simply be a change of a bit indicator at a certain location in the syntax. The reference list and layer assignment are in known formats and are at known syntax parameter, heading, overhead, or metadata locations. During the encoding, the updating of reference frames and/or layer assignment may be performed repeatedly for each frame that is to be re-assigned in order to accomplish the re-assignment. The inter-prediction then proceeds by using reference frames according to the updated reference lists.

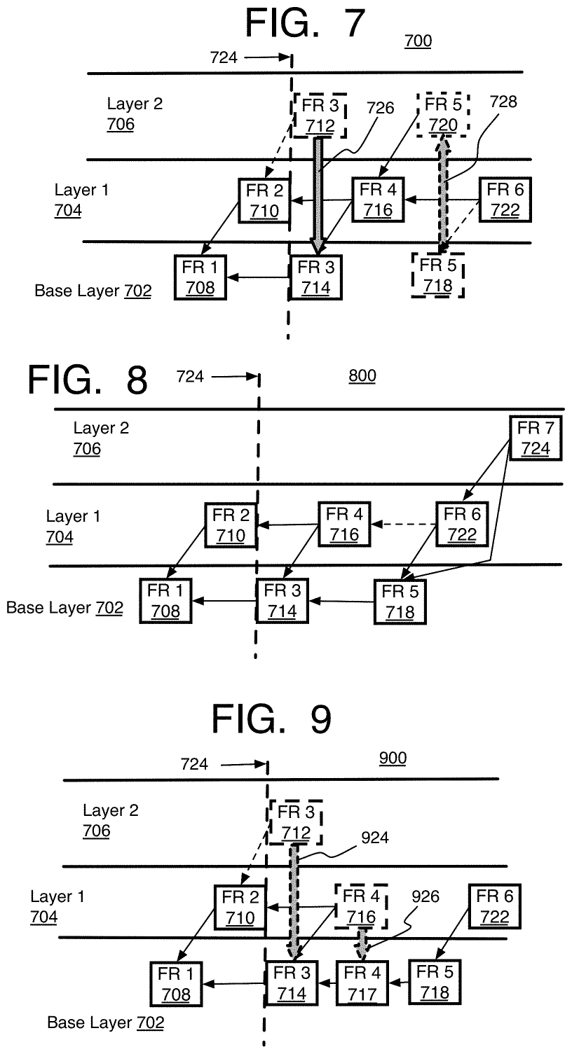

Referring to FIG. 8 to show one example resulting inter-prediction multi-layer structure 800, when flexibility is permitted with the reference dependency patterns, a multi-layer structure 800 shows the trigger frame, here frame 3 (712) may be re-assigned to position frame 3 at position 714 on the base layer 702 or lower layer 1 (704) without moving any other frame, such as frame 5 (718), to the upper layer 2 (706) whether to complete the pattern or to balance frame counts on the layers to better ensure frame rates as described below. Thus, this alternative may be provided simply to re-assign the first trigger frame that is both first trigger frame in its layer and the first trigger frame of all upper layers triggered by the same scene change 724. In this case, just the first trigger frame 3 (714) is re-assigned to the base layer 702 alone without re-assigning any other frames. Thus, in this form, other trigger frames such as frame 4 (716) may be a trigger frame in reaction to scene change 724, but is not moved at all.

Referring to FIG. 9, in another example, each first trigger frame of each layer may be lowered to a lower upper layer or to the base layer. Here, a multi-layer inter-prediction structure 900 shows each first trigger frame of an upper layer is re-assigned to the base layer. Thus, frames 3 (712) and 4 (716) are re-assigned as shown by thick arrows 924 and 926 to the base layer to form positions 714 and 917 respectively. As a result, structure 900 maintains the temporal structure including the reference frame dependency patterns and frame assignments of subsequent frames starting with the next base frame 5 (718) that was affected by scene change 724 and thereafter along the video sequence. Such an approach better ensures that all subsequent trigger frames (4 and 5 in this example) after the very first scene change trigger frame for any layer (here frame 3) also will have reference frames within the new scene to improve performance and quality.

Process 600 also may include “modify reference frame dependencies to use re-assigned frame as a reference frame” 622. This refers to changing the reference lists of the subsequent frames that will use the first trigger frame of all upper layers, or other re-assigned frames, as reference frames. In the case of structures 700, 800, and 900 (FIGS. 7-9), a new dependency is added from frame 4 (716, now at position 717) to frame 3 (714). On structure 900, the dependency between frame 6 (722) and frame 4 (716) is eliminated, while a dependency from frame 5 (718) to frame 4 (717) also is added to permit the dependency patterns to continue from frame 5 onward as described above. The re-assignment operations to generate these structures include “determine initial layer and dependency of frame” 624 and “change reference list and/or layer assignment of frame” 626 as described above with operations 616, 618, and 620, and the explanations do not need to repeated here.

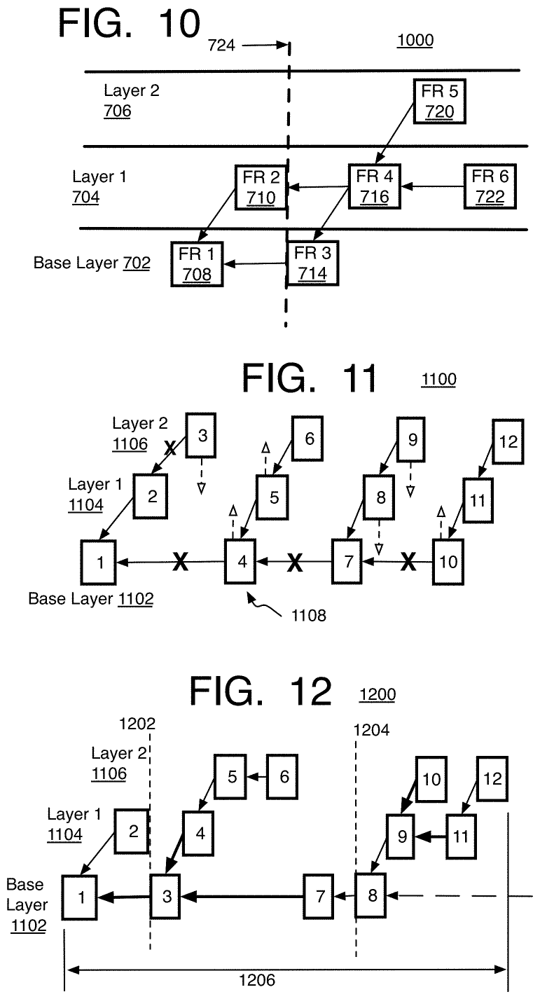

Referring to FIG. 10, optionally, process 600 may include “move frame from lower layer to upper layer” 628. This may be performed for at least one of two reasons: to compensate for the downward re-assigned frame(s) to maintain the frame rate added by each frame, which is accomplished by maintaining a frame count along a specified length of the video sequence of frames, and/or to better maintain repeating reference frame dependency patterns along the video sequence. Often both advantages are accomplished by moving the same frames. Thus, process 600 may include “move frame rate balancing frame(s)” 630. In this case, initial frame 5 (718) as shown on structure 700 (FIG. 7) may be moved to the higher layer 2 (706) so that frame 5 (now 720 as re-assigned) helps to maintain a frame count on layer 2 (706), and in turn the layer-based frame rates or bit rates. Particularly, this upward movement of frames maintains a count of frames on a layer over a certain frame sequence length, and in turn, maintain required target frame-rate ratios between the temporal layers. This operation can be optional, however, when it merely affects a small number of frames and may not be noticeable to a viewer watching the video.

Likewise, this operation of upward movement of frames also may include “move frame(s) to keep dependency pattern” 632, and depending on the codec and/or the applications being used, the temporal multi-layer reference dependency patterns may need to be followed strictly. In this case, trigger frame 3 (now 714) may be treated as restarting a reference dependency pattern of 3 frames across all of the layers so that frame 3 (714) may be placed on the base layer 702 to repeat the three-frame, three-layer pattern as initially started at frame 1 (708). In this case then, frame 5 (718) also would be moved upward, as shown by thick arrow 728 (FIG. 7), from the base layer 702 to upper layer 2 (706) to position 720 to complete a three layer, cross-layer pattern (with frames 3, 4, and 5). The completed structure is shown on FIG. 10 with multi-layer structure 800 and re-assigned frames 714 and 720.

Optionally, process 600 may include “modify reference frame dependencies and/or layer assignment to use balancing/pattern frame as a reference frame” 634, where here also, the frame dependencies may change to use at least the first trigger frame (here frame 3) as a reference frame. Thus, the initial dependency from frame 6 to frame 5 would be eliminated and a new frame dependency from frame 5 (720) to frame 4 (716) would be added since now frame 5 (720) is in a higher layer than frame 4 (716).

Referring to FIGS. 11-12 as yet another example, an initial multi-layer inter-prediction structure 1100 and resulting structure 1200 is provided to show dynamic temporal layer management. Specifically, frames can be re-assigned from layer to layer in this example to best maintain a frame count, and in turn a frame rate, during a convergence period where trigger frames are detected. This is instead of rigidly maintaining the frame dependency patterns, and even more flexible than permitting slight flexibility with reference dependency patterns that still limits the re-assignment of the trigger frames to the base or lower layers as described above with structure 900. Here, instead, the emphasis is on frame count regardless of repeating reference frame patterns that occur along the video sequence. This alternative may permit any deviation from the patterns as long as target frame rate ratios between layers are being maintained.

To demonstrate this example, structure 1100 initially has frames 1-12 in three layers 1102, 1104, 1106, with the frames being grouped into repeating three frame reference dependency patterns 1108 (such as one pattern being formed of frame 4, 5, and 6). A convergence length 1206 (FIG. 12) extends on structure 1200 from just before the content event, such as a scene change 1202, and until the frame dependency patterns can continue unaffected by the content events. The reference frame dependencies may be adjusted within this convergence by re-assignments with the goal to keep the convergence as short as possible in number of frames along the video sequence, while still maintaining frame rate ratios between the frames within the convergence.

In this example, two scene changes 1202 and 1204 occur very close to each other, where frame 3 is the first trigger frame of all upper layers, and is therefore re-assigned to the base layer 1102. To maintain a semblance of the repeating pattern while maintain the claim count within the convergence 1206, frames 4 and 5 are re-assigned and moved up respectively to an upper layer. The dependency from claim 5 to claim 4 is maintained. This re-assignment or movement of the frames is shown on structure 1100 by the dashed arrows, while the change in dependency is shown by the X on structure 700 that indicates a dependency is eliminated, while the thicker arrows on structure 1200 shows a dependency is new. Thus, the dependencies between frame 2 and 3; 1 and 4; and 4 and 7 are removed, while new dependencies are added between frames 1 and 3; 3 and 4; and 4 and 7. The second scene change 1204 occurs before frame 8 so that frame 8 becomes another first trigger frame for all upper layers and frame 8 is re-assigned to the base layer. In this case, subsequent frames are changed differently than that of frame 3 where frame 11 now depends from frame 9 instead of frame 10. The result is that four frames are maintained on each layer, including the base layer and within the convergence 1206, which is the same per-layer frame count before the re-assignments, even though no frame pattern is being strictly followed now.

With this arrangement then, the convergence 1206 can be the time period used to meet a target frame rate (where by default, the convergence is one second). In this example, three layers are used for encoding with base, 1, and 2 layers at 10 fps, 20 fps, and 30 fps respectively. The codec or applications being used may permit momentary frame-rate fluctuations. In this case, the convergence 1206 may be set to two seconds, which refers to having the base layer produce 20 frames per two seconds, layer 1 with 40 frames per two seconds, and layer 2 with 60 frames per two seconds, but the exact momentary pattern can vary and, by one form, can be defined or limited only by a framework of a media application programming interface (API), for one example.

Process 600 may include “continue encoding frames at layers” 636. Where after convergence, the layers proceed with encoding frames in their initial assignments until another frame is detected as a re-assignment trigger (or detect to have content likely to cause a delay). The frames are used as reference frames for inter-prediction at the decoding loop during encoding per their assignments to the layers to maintain the target frame rates or bit rates of the layers as described above.

The multi-layer encoded frames are packed into a single bitstream, in contrast to multi-channel enhancement encoding that maintains separate bitstreams each with multiple enhancement quality and/or performance differences from each other. The decoder that receives the multi-layer bitstream then selects frames only on the layers that will generate a target frame rate or bit rate handled by the decoder. The frames of the non-selected upper layers are dropped by the decoder (e.g., not decoded when frame markers are reached on the bitstream or not decoded any further when entropy decoding is needed to identify the frame locations). All of the frames could be stored anyway for future possible use or transcoding for example.

While implementation of the example processes 500 and 600 discussed herein may include the undertaking of all operations shown in the order illustrated, the present disclosure is not limited in this regard and, in various examples, implementation of the example processes herein may include only a subset of the operations shown, operations performed in a different order than illustrated, or additional or less operations.

In addition, any one or more of the operations discussed herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more graphics processing unit(s) or processor core(s) may undertake one or more of the blocks of the example processes herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the operations discussed herein and/or any portions the devices, systems, or any module or component as discussed herein.

As used in any implementation described herein, the term “module” refers to any combination of software logic, firmware logic, hardware logic, and/or circuitry configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, fixed function circuitry, execution unit circuitry, and/or firmware that stores instructions executed by programmable circuitry. The modules may, collectively or individually, be embodied as circuitry that forms part of a larger system, for example, an integrated circuit (IC), system on-chip (SoC), and so forth.

As used in any implementation described herein, the term “logic unit” refers to any combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

The terms “circuit” or “circuitry,” as used in any implementation herein, may comprise or form, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor (“processor circuitry”) and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smartphones, etc. Other implementations may be implemented as software executed by a programmable control device. In such cases, the terms “circuit” or “circuitry” are intended to include a combination of software and hardware such as a programmable control device or a processor capable of executing the software. As described herein, various implementations may be implemented using hardware elements, software elements, or any combination thereof that form the circuits, circuitry, processor circuitry. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

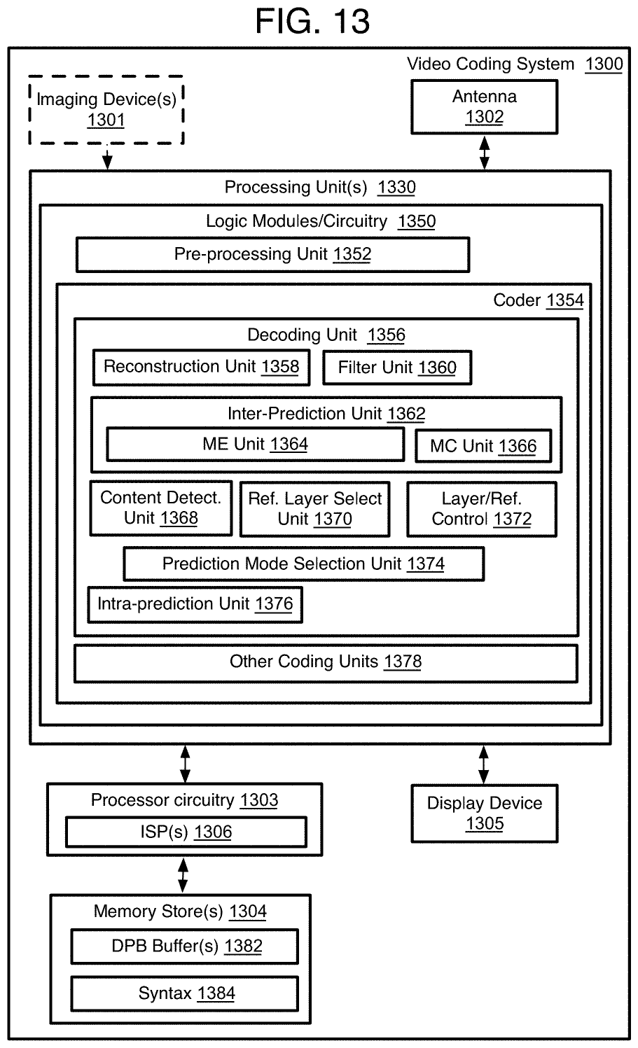

Referring to FIG. 13, an example image processing system (or video coding system) or device 1300 for multi-layer video coding is arranged in accordance with at least some implementations of the present disclosure. In the illustrated implementation, system 1300 may include processor circuitry 1303 that forms one or more processor(s) and therefore may be referred to as processor(s), processing unit(s) 1330 to at least provide the encoder discussed herein and may include a decoder as well, optionally one or more imaging devices 1301 to capture images, an antenna 1302 to receive or transmit image data, optionally a display device 1305, and one or more memory stores 1304. Processor(s) 1303, memory store 1304, and/or display device 1305 may be capable of communication with one another, via, for example, a bus, wires, or other access. In various implementations, display device 1305 may be integrated in system 1300 or implemented separately from system 1300.

As shown in FIG. 13, and discussed above, the processing unit(s) 1330 may have logic modules or circuitry 1350 with a pre-processing unit 1352 that modifies image data for coding, and a coder 1354 that could be or include an encoder 300. Relevant here, the coder 1354 may have a decoding loop unit 1356 with a reconstruction unit 1358 to reconstruct transformed and quantized image data, a filter unit 1360 to refine the reconstructed image data, an inter-prediction unit 1362, an intra-prediction unit 1376, and relevant to the re-assignment operations described herein, a content detection unit 1368, the same or similar to image content detection unit 328 (FIG. 3) above, reference layer selection unit 1370 (or 330), and a layer/reference control unit (or 332) with operations to re-assign frames from one layer to another layer to control frame rate and/or bit rate according to the disclosed implementations and methods as described above. The inter-prediction unit 1362 (or 324) may have an ME unit 1364 (or 328) that matches image data between a reference frame and a current frame being reconstructed to determine motion vectors from one frame to the other, and an MC unit 1366 (or 330) that uses the motion vectors to generate predictions of image data blocks or other partitions of a frame. A prediction mode selection unit 1374 may select the final prediction mode that is used to generate a residual of an image data block or other frame partition to modify the original data and for compression, and to reconstruct frames on the decoding loop of the encoder. The coder 1354 also may have other coding units 1378 which may include video coding units not mentioned including any or all of the other units of the encoder 300 described above for example. All of these perform the tasks as described in detail above and as the title of the unit, circuit, or module suggests. It also will be understood that coder 1354 also may include a decoder 400 when desired.

As will be appreciated, the modules (or circuits) illustrated in FIG. 13 may include a variety of software and/or hardware modules and/or modules that may be implemented via software or hardware or combinations thereof. For example, the modules may be implemented as software via processing units 1330 or the modules may be implemented via a dedicated hardware portion or processor circuitry 1303. Also, system 1300 may be implemented in a variety of ways. For example, system 1300 (excluding display device 1305) may be implemented as processor circuitry with a single chip or device having an accelerator or a graphics processor unit (GPU) which may or may not have image signal processors (ISPs) 1306, a quad-core central processing unit, and/or a memory controller input/output (I/O) module. In other examples, system 1300 (again excluding display device 1305) may be implemented as a chipset or a system on a chip (SoC). It will be understood antenna 1302 could be used to receive image data for encoding as well.

Otherwise, processor(s) (or processor circuitry) 1303 may include any suitable implementation including, for example, central processing units (CPUs), microprocessor(s), multicore processors, application specific integrated circuits, chip(s), chipsets, programmable logic devices, graphics cards, integrated graphics, general purpose graphics processing unit(s), fixed function GPUs such as with the image signal processors (ISPs) 1306, digital signal processor(s) (DSPs), and so forth. In one form, the processor(s) include at least one Intel® Atom processor.

In addition, memory stores 1304 may store the DPB buffer(s) 1382 reconstructed (decoded) image data to form the reference frames as described above and may have syntax memory or buffer 1384 to store overhead or header data to accompany the image data in a bit stream and including reference lists and layer assignments as described above. The memory also may store a version of original image data. The memory stores 1304 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 1304 also may be implemented via cache memory.

In various implementations, the example video coding system 1300 may use the imaging device 1301 to form or receive captured raw image data, while the memory, via transmission to the system 1300, may receive video sequence images transmitted from other devices or systems. Thus, the system 1300 may receive screen content through the camera, antenna 1302, or wired connection. The camera can be implemented in various ways. Thus, in one form, the image processing system 1300 may be one or more digital cameras or other image capture devices, and imaging device 1301, in this case, may be the camera hardware and camera sensor software, module, or component. In other examples, video coding system 1300 may have an imaging device 1301 that includes or may be one or more cameras, and logic modules 1350 may communicate remotely with, or otherwise may be communicatively coupled to, the imaging device 1301 for further processing of the image data.

Thus, video coding system 1300 may be, or may be part of, or may be in communication with, a smartphone, tablet, laptop, or other mobile device such as wearables including smart glasses, smart headphones, exercise bands, and so forth. In any of these cases, such technology may include a camera such as a digital camera system, a dedicated camera device, or an imaging phone or tablet, whether a still picture or video camera, camera that provides a preview screen, or some combination of these. Thus, in one form, imaging device 1301 may include camera hardware and optics including one or more sensors as well as auto-focus, zoom, aperture, ND-filter, auto-exposure, flash, and actuator controls. The imaging device 1301 also may have a lens, an image sensor with a RGB Bayer color filter, an analog amplifier, an A/D converter, other components to convert incident light into a digital signal, the like, and/or combinations thereof. The digital signal also may be referred to as the raw image data herein.

Other forms include a camera sensor-type imaging device or the like (for example, a webcam or webcam sensor or other complementary metal-oxide-semiconductor-type image sensor (CMOS)), without the use of a red-green-blue (RGB) depth camera and/or microphone-array to locate who is speaking. In other examples, an RGB-Depth camera and/or microphone-array might be used in addition to or in the alternative to a camera sensor. In some examples, imaging device 1301 may be provided with an eye tracking camera. Otherwise, the imaging device 1301 may be any other device that records, displays or processes digital images such as video game panels or consoles, set top boxes, and so forth.

As illustrated, any of these components may be capable of communication with one another and/or communication with portions of logic modules 1350 and/or imaging device 1301. Thus, processors 1303 may be communicatively coupled to both the image device 1301 and the logic modules 1350 for operating those components. Although image processing system 1300, as shown in FIG. 13, may include one particular set of blocks or actions associated with particular components or modules (or circuits), these blocks or actions may be associated with different components or modules than the particular component or module illustrated here.

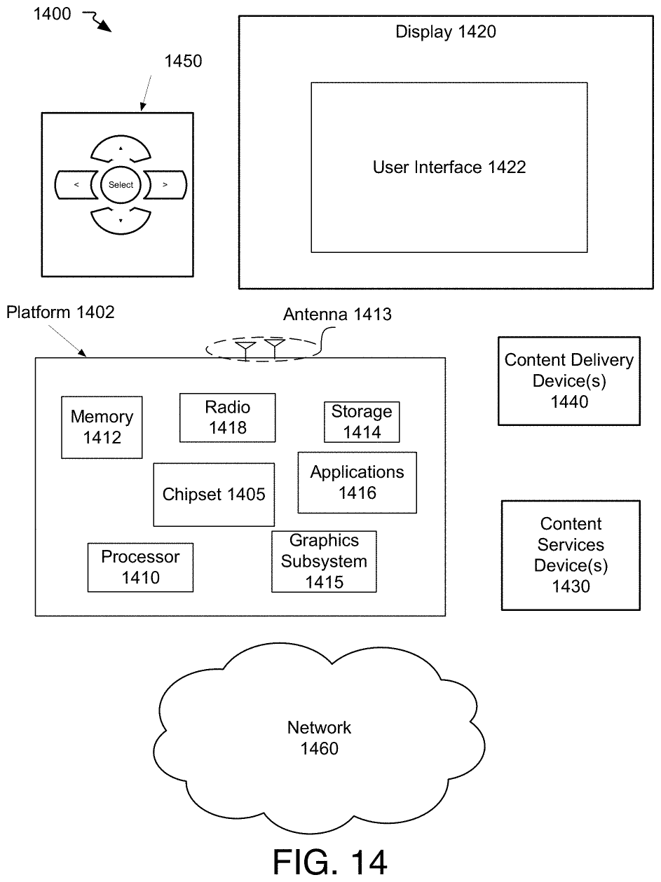

FIG. 14 is an illustrative diagram of an example system 1400, arranged in accordance with at least some implementations of the present disclosure. In various implementations, system 1400 may be a mobile system although system 1400 is not limited to this context. For example, system 1400 may be incorporated into a personal computer (PC), server, laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, cameras (e.g. point-and-shoot cameras, super-zoom cameras, digital single-lens reflex (DSLR) cameras), and so forth.

In various implementations, system 1400 includes a platform 1402 coupled to a display 1420. Platform 1402 may receive content from a content device such as content services device(s) 1430 or content delivery device(s) 1440 or other similar content sources. A navigation controller 1450 including one or more navigation features may be used to interact with, for example, platform 1402 and/or display 1420. Each of these components is described in greater detail below.

In various implementations, platform 1402 may include any combination of a chipset 1405, processor 1410, memory 1412, antenna 1413, storage 1414, graphics subsystem 1415, applications 1416 and/or radio 1418. Chipset 1405 may provide intercommunication among processor 1410, memory 1412, storage 1414, graphics subsystem 1415, applications 1416 and/or radio 1418. For example, chipset 1405 may include a storage adapter (not depicted) capable of providing intercommunication with storage 1414.

Processor 1410 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 1410 may be dual-core processor(s), dual-core mobile processor(s), and so forth.

Memory 1412 may be implemented as a volatile memory device such as, but not limited to, a Random Access Memory (RAM), Dynamic Random Access Memory (DRAM), or Static RAM (SRAM).

Storage 1414 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1414 may include technology to increase the storage performance enhanced protection for valuable digital media when multiple hard drives are included, for example.

Graphics subsystem 1415 may perform processing of images such as still or video for display. Graphics subsystem 1415 may be a graphics processing unit (GPU) or a visual processing unit (VPU), for example. An analog or digital interface may be used to communicatively couple graphics subsystem 1415 and display 1420. For example, the interface may be any of a High-Definition Multimedia Interface, DisplayPort, wireless HDMI, and/or wireless HD compliant techniques. Graphics subsystem 1415 may be integrated into processor 1410 or chipset 1405. In some implementations, graphics subsystem 1415 may be a stand-alone device communicatively coupled to chipset 1405.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In further implementations, the functions may be implemented in a consumer electronics device.

Radio 1418 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1418 may operate in accordance with one or more applicable standards in any version.

In various implementations, display 1420 may include any television type monitor or display. Display 1420 may include, for example, a computer display screen, touch screen display, video monitor, television-like device, and/or a television. Display 1420 may be digital and/or analog. In various implementations, display 1420 may be a holographic display. Also, display 1420 may be a transparent surface that may receive a visual projection. Such projections may convey various forms of information, images, and/or objects. For example, such projections may be a visual overlay for a mobile augmented reality (MAR) application. Under the control of one or more software applications 1416, platform 1402 may display user interface 1422 on display 1420.

In various implementations, content services device(s) 1430 may be hosted by any national, international and/or independent service and thus accessible to platform 1402 via the Internet, for example. Content services device(s) 1430 may be coupled to platform 1402 and/or to display 1420. Platform 1402 and/or content services device(s) 1430 may be coupled to a network 1460 to communicate (e.g., send and/or receive) media information to and from network 1460. Content delivery device(s) 1440 also may be coupled to platform 1402 and/or to display 1420.

In various implementations, content services device(s) 1430 may include a cable television box, personal computer, network, telephone, Internet enabled devices or appliance capable of delivering digital information and/or content, and any other similar device capable of uni-directionally or bi-directionally communicating content between content providers and platform 1402 and/display 1420, via network 1460 or directly. It will be appreciated that the content may be communicated uni-directionally and/or bi-directionally to and from any one of the components in system 1400 and a content provider via network 1460. Examples of content may include any media information including, for example, video, music, medical and gaming information, and so forth.

Content services device(s) 1430 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1402 may receive control signals from navigation controller 1450 having one or more navigation features. The navigation features of may be used to interact with user interface 1422, for example. In various implementations, navigation may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of may be replicated on a display (e.g., display 1420) by movements of a pointer, cursor, focus ring, or other visual indicators displayed on the display. For example, under the control of software applications 1416, the navigation features located on navigation may be mapped to virtual navigation features displayed on user interface 1422, for example. In various implementations, may not be a separate component but may be integrated into platform 1402 and/or display 1420. The present disclosure, however, is not limited to the elements or in the context shown or described herein.

In various implementations, drivers (not shown) may include technology to enable users to instantly turn on and off platform 1402 like a television with the touch of a button after initial boot-up, when enabled, for example. Program logic may allow platform 1402 to stream content to media adaptors or other content services device(s) 1430 or content delivery device(s) 1440 even when the platform is turned “off.” In addition, chipset 1405 may include hardware and/or software support for 5.1 surround sound audio and/or high definition 14.1 surround sound audio, for example. Drivers may include a graphics driver for integrated graphics platforms. In various implementations, the graphics driver may include a peripheral component interconnect (PCI) Express graphics card.

In various implementations, any one or more of the components shown in system 1400 may be integrated. For example, platform 1402 and content services device(s) 1430 may be integrated, or platform 1402 and content delivery device(s) 1440 may be integrated, or platform 1402, content services device(s) 1430, and content delivery device(s) 1440 may be integrated, for example. In various implementations, platform 1402 and display 1420 may be an integrated unit. Display 1420 and content service device(s) 1430 may be integrated, or display 1420 and content delivery device(s) 1440 may be integrated, for example. These examples are not meant to limit the present disclosure.

In various implementations, system 1400 may be implemented as a wireless system, a wired system, or a combination of both. When implemented as a wireless system, system 1400 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1400 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1402 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner The implementations, however, are not limited to the elements or in the context shown or described in FIG. 14.

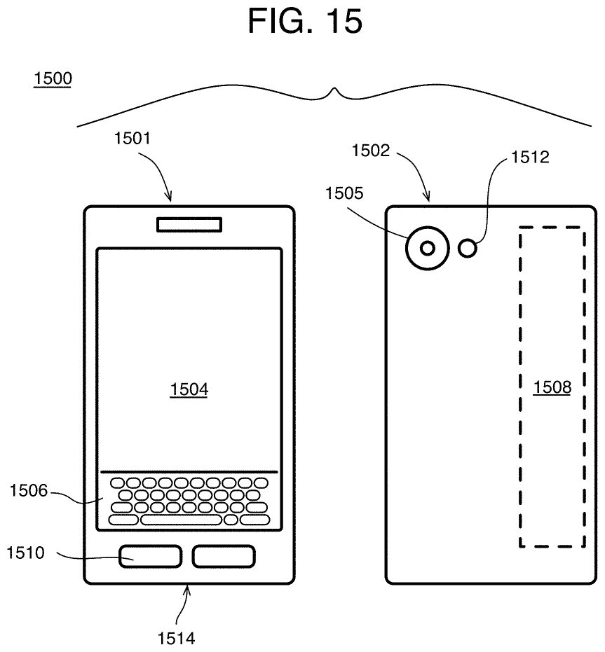

As described above, system 1300 or 1400 may be embodied in varying physical styles or form factors. FIG. 15 illustrates an example small form factor device 1500, arranged in accordance with at least some implementations of the present disclosure. In some examples, system 1300 or 1400 may be implemented via device 1500. In other examples, system or coders 300, 400, or portions thereof may be implemented via device 1500. In various implementations, for example, device 1500 may be implemented as a mobile computing device having wireless capabilities. A mobile computing device may refer to any device having a processing system and a mobile power source or supply, such as one or more batteries, for example.

Examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, smart device (e.g., smart phone, smart tablet or smart mobile television), mobile internet device (MID), messaging device, data communication device, cameras, and so forth.

Examples of a mobile computing device also may include computers that are arranged to be worn by a person, such as a wrist computer, finger computers, ring computers, eyeglass computers, belt-clip computers, arm-band computers, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 15, device 1500 may include a housing with a front 1501 and a back 1502. Device 1500 includes a display 1504, an input/output (I/O) device 1506, and an integrated antenna 1508. Device 1500 also may include navigation features 1510. I/O device 1506 may include any suitable I/O device for entering information into a mobile computing device. Examples for I/O device 1506 may include an alphanumeric keyboard, a numeric keypad, a touch pad, input keys, buttons, switches, microphones, speakers, voice recognition device and software, and so forth. Information also may be entered into device 1500 by way of microphone (not shown), or may be digitized by a voice recognition device. As shown, device 1500 may include one or more cameras 1505 (e.g., including a lens, an aperture, and an imaging sensor) and a flash 1512 integrated into back 1502 (or elsewhere) of device 1500. In other examples, camera 1505 and flash 1512 may be integrated into front 1501 of device 1500 or both front and back cameras may be provided. Camera 1505 and flash 1512 may be components of a camera module to originate image data processed into streaming video that is output to display 1504 and/or communicated remotely from device 1500 via antenna 1508 for example.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one implementation may be implemented by representative instructions stored on a machine-readable medium which represents various logic within the processor, which when read by a machine causes the machine to fabricate logic to perform the techniques described herein. Such representations, known as IP cores, may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

In one or more first implementations, a device for video coding comprises memory to store at least one video; and at least one processor communicatively coupled to the memory and being arranged to operate by:

The following examples pertain to additional implementations.

By one or more example first implementations, a computer-implemented method of video coding comprising: decoding a video sequence of frames at multiple layers to provide multiple alternative frame rates; and re-assigning at least one frame from one of the layers to another of the layers to use the re-assigned frame as a reference frame of at least one other frame of the multiple layers.

By one or more second implementation, and further to the first implementation, the method comprising re-assigning at least one frame from a higher layer frame associated with a faster frame rate to a lower layer frame associated with a slower frame rate.

By one or more third implementations, and further to the first implementation, the method comprising re-assigning at least one frame from a higher layer frame associated with a faster frame rate to a lower layer frame associated with a slower frame rate; and using the re-assigned frame as a reference frame by other frames on the lower layer that is the same layer with the re-assigned frame and for inter-prediction.

By one or more fourth implementations, and further to the first implementation, the method comprising re-assigning at least one frame from a higher layer frame associated with a faster frame rate to a lower layer frame associated with a slower frame rate, wherein the lower layer is a base layer with the slowest frame rate of the multiple layers.

By one or more fifth implementations, and further to any of the first to fourth implementation, the method comprising re-assigning the at least one frame depending on image data content of the at least one frame.

By one or more sixth implementations, and further to any of the first to fourth implementation, the method comprising re-assigning the at least one frame depending on image data content of the at least one frame; and detecting whether or not the at least one frame is a frame that has image data content that tends to cause delay in coding image data.

By one or more seventh implementations, and further to any of the first to fourth implementation, the method comprising re-assigning the at least one frame depending on image data content of the at least one frame; and detecting whether or not the at least one frame is a frame that has image data content that tends to cause delay in coding image data.

By one or more eighth implementations, and further to any of the first to fourth implementation, the method comprising re-assigning the at least one frame depending on image data content of the at least one frame; and wherein at least one frame directly after a trigger frame is re-assigned to a different layer.

By one or more ninth implementations, and further to any of the first to eighth implementation, the method comprising moving one or more frames from a lower layer to a higher layer relative to the lower layer, wherein the upper layer is missing the at least one re-assigned frame, and the frame(s) from a lower layer being moved to maintain a same original count of frames on the layers.

By one or more example tenth implementations, A computer-implemented system of video coding comprising: memory storing at least image data of a video sequence of frames; and processor circuitry communicatively coupled to the memory and forming at least one processor arranged to be operated by: decoding video frames of a video sequence at multiple layers to form multiple video sequences each with a different frame rate; and re-assigning at least one frame from one of the layers to another of the layers to use the re-assigned frame as an inter-prediction reference frame and the re-assignment depending on the detection of delay-causing image data content of at least one of the frames.

By one or more eleventh implementations, and further to the tenth implementation, wherein the delay-causing image data content indicates a scene change or fast motion.

By one or more twelfth implementations, and further to the tenth or eleventh implementation, wherein only a first frame of all upper layers found to have the delay-causing content is re-assigned to a lower layer.

By one or more thirteenth implementations, and further to any of the tenth to twelfth implementation, wherein each upper layer of the multiple layers has a first frame found to have the delay-causing content, wherein the processor being arranged to operate by setting the first of the first frames in decoding order as a reference frame of at least one of the other first frames.

By one or more fourteenth implementations, and further to any of the tenth to thirteenth implementation, wherein a first frame of each upper layer found to have the delay-causing content is re-assigned to a lower layer.

By one or more fifteenth implementation, and further to any of the tenth to fourteenth implementation, wherein the re-assigned layer is re-assigned from a highest available layer to a base layer of the multiple layers.

By an example sixteenth implementation, and further to any of the tenth to fifteenth implementation, wherein the processor is arranged to operate by moving one or more frames from a lower layer to a higher layer relative to the lower layer, wherein the upper layer is missing the at least one re-assigned frame, and the frame(s) of the lower layer being moved to maintain a same original count of frames on the layers.

By one or more example seventeenth implementation, at least one non-transitory machine readable medium comprises a plurality of instructions that, in response to being executed on a computing device, cause the computing device to operate by: decoding a video sequence of frames at multiple layers to provide multiple alternative frame rates; and re-assigning at least one frame from one of the layers to another of the layers to use the re-assigned frame as a reference frame of at least one other frame of the multiple layers.

By one or more eighteenth implementations, and further to the seventeenth implementation, wherein the re-assigning depends on detection of image data content of a frame that is considered to cause processing delays.

By one or more nineteenth implementations, and further to the seventeenth or eighteenth implementation, wherein the image data content is image data that indicates a scene change or fast motion.

By one or more twentieth implementations, and further to any of the seventeenth to nineteenth implementation, wherein the instructions cause the computing device to operate by re-assigning one or more frames both from a current layer to a lower frame and one or more frames from a current layer to an upper layer, wherein upper and lower are relative to the current layer of a frame.

By one or more twenty-first implementations, and further to any of the seventeenth to twentieth implementation, wherein the instructions cause the computing device to operate by re-assigning at least one frame on a base layer to an upper layer to maintain a target frame rate associated within one of the layers.

By one or more twenty-second implementation, and further to any of the seventeenth to twenty-first implementation, wherein the instructions cause the computing device to operate by re-assigning at least one frame on a base layer to an upper layer to maintain a repeating reference frame pattern that occurs along the video sequence during inter-prediction of the frames in the video sequence.

By one or more twenty-third implementation, and further to any of the seventeenth to twenty-first implementation, wherein repeating frame dependency patterns involving all of the layers is disregarded and frames are re-assigned to different layers to maintain a count of frames per layer in a convergence length of video.

By one or more twenty-fourth implementation, and further to any of the seventeenth to twenty-third implementation, wherein only a single first trigger frame of all upper layers not including a base layer is re-assigned to the base layer, wherein a trigger frame is found to have delay-causing image data content.

By one or more twenty-fifth implementation, and further to any of the seventeenth to twenty-third implementation, wherein each first trigger frame of each upper layer is re-assigned to a base layer, wherein a trigger frame is found to have delay-causing image data content.

In one or more twenty-sixth implementations, at least one machine readable medium includes a plurality of instructions that in response to being executed on a computing device, cause the computing device to perform a method according to any one of the above implementations.

In one or more twenty-seventh implementations, an apparatus may include means for performing a method according to any one of the above implementations.

It will be recognized that the implementations are not limited to the implementations so described, but can be practiced with modification and alteration without departing from the scope of the appended claims. For example, the above implementations may include specific combination of features. However, the above implementations are not limited in this regard and, in various implementations, the above implementations may include the undertaking only a subset of such features, undertaking a different order of such features, undertaking a different combination of such features, and/or undertaking additional features than those features explicitly listed. The scope of the implementations should, therefore, be determined with reference to the appended claims, along with the full scope of equivalents to which such claims are entitled.

What is claimed is:

1. A computer-implemented method of video coding comprising:
decoding a video sequence of frames at multiple layers to provide multiple alternative frame rates; and
re-assigning at least one frame from one of the layers to another of the layers to use the re-assigned frame as a reference frame of at least one other frame of the multiple layers.

2. The method of claim 1, comprising re-assigning at least one frame from a higher layer frame associated with a faster frame rate to a lower layer frame associated with a slower frame rate.

3. The method of claim 2, comprising using the re-assigned frame as a reference frame by other frames on the lower layer that is the same layer with the re-assigned frame and for inter-prediction.

4. The method of claim 2, wherein the lower layer is a base layer with the slowest frame rate of the multiple layers.

5. The method of claim 1, comprising re-assigning the at least one frame depending on image data content of the at least one frame.

6. The method of claim 5 comprising detecting whether or not the at least one frame is a frame that has image data content that tends to cause delay in coding image data.

7. The method of claim 5 comprising detecting whether or not the at least one frame indicates a scene change or fast motion to trigger the re-assigning of the at least one frame.

8. The method of claim 5 wherein at least one frame directly after a trigger frame is re-assigned to a different layer.

9. The method of claim 1, comprising moving one or more frames from a lower layer to a higher layer relative to the lower layer, wherein the upper layer is missing the at least one re-assigned frame, and the frame(s) from a lower layer being moved to maintain a same original count of frames on the layers.

10. A computer-implemented system of video coding comprising:
memory storing at least image data of a video sequence of frames; and
processor circuitry communicatively coupled to the memory and forming at least one processor arranged to be operated by:
decoding video frames of a video sequence at multiple layers to form multiple video sequences each with a different frame rate; and
re-assigning at least one frame from one of the layers to another of the layers to use the re-assigned frame as an inter-prediction reference frame and the re-assignment depending on the detection of delay-causing image data content of at least one of the frames.

11. The system of claim 10 wherein the delay-causing image data content indicates a scene change or fast motion.

12. The system of claim 10 wherein only a first frame of all upper layers found to have the delay-causing content is re-assigned to a lower layer.

13. The system of claim 10, wherein each upper layer of the multiple layers has a first frame found to have the delay-causing content, wherein the processor being arranged to operate by setting the first of the first frames in decoding order as a reference frame of at least one of the other first frames.

14. The system of claim 10 wherein a first frame of each upper layer found to have the delay-causing content is re-assigned to a lower layer.

15. The system of claim 10 wherein the re-assigned layer is re-assigned from a highest available layer to a base layer of the multiple layers.

16. The system of claim 10 wherein the processor is arranged to operate by moving one or more frames from a lower layer to a higher layer relative to the lower layer, wherein the upper layer is missing the at least one re-assigned frame, and the frame(s) of the lower layer being moved to maintain a same original count of frames on the layers.

17. At least one non-transitory machine readable medium comprising a plurality of instructions that, in response to being executed on a computing device, cause the computing device to operate by:
decoding a video sequence of frames at multiple layers to provide multiple alternative frame rates; and
re-assigning at least one frame from one of the layers to another of the layers to use the re-assigned frame as a reference frame of at least one other frame of the multiple layers.

18. The medium of claim 17, wherein the re-assigning depends on detection of image data content of a frame that is considered to cause processing delays.

19. The medium of claim 17, wherein the image data content is image data that indicates a scene change or fast motion.

20. The medium of claim 17, wherein the instructions cause the computing device to operate by re-assigning one or more frames both from a current layer to a lower frame and one or more frames from a current layer to an upper layer, wherein upper and lower are relative to the current layer of a frame.

21. The medium of claim 17, wherein the instructions cause the computing device to operate by re-assigning at least one frame on a base layer to an upper layer to maintain a target frame rate associated within one of the layers.

22. The medium of claim 17, wherein the instructions cause the computing device to operate by re-assigning at least one frame on a base layer to an upper layer to maintain a repeating reference frame pattern that occurs along the video sequence during inter-prediction of the frames in the video sequence.

23. The medium of claim 17, wherein repeating frame dependency patterns involving all of the layers is disregarded and frames are re-assigned to different layers to maintain a count of frames per layer in a convergence length of video.

24. The medium of claim 17, wherein only a single first trigger frame of all upper layers not including a base layer is re-assigned to the base layer, wherein a trigger frame is found to have delay-causing image data content.

25. The medium of claim 17, wherein each first trigger frame of each upper layer is re-assigned to a base layer, wherein a trigger frame is found to have delay-causing image data content.
